(19) United States
(12) Patent Application Publication
(10) Pub. No.: US 2021/0304335 A1
(43) Pub. Date: Sep. 30, 2021

(54) SYSTEMS AND METHODS FOR ANONYMOUS REAL ESTATE TRANSACTIONS

(71) Applicant: THE LOONEY GROUP, INC., Springfield, TN (US)

(72) Inventors: Angela Looney, Springfield, TN (US); Shane Hunnicutt, Clarksville, TN (US)

(21) Appl. No.: 16/834,771

(22) Filed: Mar. 30, 2020

(51) Int. Cl. G06Q 50/16; G06Q 40/02; H04L 29/08

(52) U.S. Cl. CPC G06Q 50/167; H04L 67/306; G06Q 40/02

(57) ABSTRACT

Systems, methods, and computer-readable media are disclosed for anonymous real estate transactions. Example methods may include receiving, by a server, personal consumer information. The methods may also include storing the personal consumer information in association with a consumer profile for a consumer. The methods may also include receiving criteria associated with a request for real estate services. The methods may also include determining, based on the criteria, a realtor profile for a realtor. The methods may also include facilitating a match between the realtor profile and consumer profile. The methods may also include receiving a first communication regarding the request for real estate services. The methods may also include sending an anonymized version of the first communication to the realtor profile, the first communication being absent of the personal consumer information. The methods may also include receiving an indication of a trusted connection with the realtor profile. The methods may also include providing, based on receiving the indication of the trusted connection with the realtor profile, the personal consumer information to the realtor profile.

### BACKGROUND

In conventional real estate transaction systems (for example, software applications and/or websites), may provide consumers the capability to input information regarding real estate they wish to buy or sell. The system may then provide a list of filtered real estate entries based on the input information to allow the consumer to view real estate entries pertinent to their desired criteria. The system may also provide a listing of realtors that the consumer may interact with to assist the consumer in performing a real estate transaction associated with one or more of the real estate entries. A consumer may also have an account with the system, and the account may include personal consumer information of the consumer. This information may either be provided to, or discoverable by, realtors that may have access to the same system.

As a result, consumers who desire to use such systems for real estate transactions may be subjected to constant emails and telephone calls from realtors who are able to use the system to obtain the consumer's information. Additionally, consumers may desire to interact with a realtor, but any communications sent by the consumer to the realtor may also include personal consumer information. Further, the communications may include identifying information for a consumer device from which the consumer accesses the real estate transaction system.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is an example use case of an anonymous real estate transaction system in accordance with one or more example embodiments of the disclosure

FIG. 2 is a schematic illustration of an example system architecture in accordance with one or more example embodiments of the disclosure.

FIG. 3A is an example system flow diagram from a consumer perspective in accordance with one or more example embodiments of the disclosure.

FIG. 3B is an example system flow diagram from a realtor perspective in accordance with one or more example embodiments of the disclosure.

FIG. 4 is an example method in accordance with one or more example embodiments of the disclosure.

FIG. 5 is an example method in accordance with one or more example embodiments of the disclosure.

### DETAILED DESCRIPTION

### Overview

This disclosure relates to, among other things, systems, methods, computer-readable media, techniques, and methodologies for anonymous real estate transactions. In some embodiments, such real estate transactions may involve interactions between a consumer and a realtor through a real estate transaction system (which may also be referred to hereinafter as “the system”). In some instances, the real estate transaction system may be, for example, a website or a smartphone application used by a consumer to post real estate for sale or to search for real estate to purchase. In such instances, the real estate transaction system itself may be executed by a server, and a consumer and/or realtor may use the smartphone application, website, or other application to access the system at the server. In using the real estate transaction system, the consumer may create a consumer profile that may be saved within the system. The consumer profile may include various types of information associated with the consumer, such as personal consumer information, information about real estate the consumer has posted for sale, information about preferences with respect to real estate the consumer is searching for to purchase, saved real estate postings, etc. The consumer profile may also allow the consumer to interact with one or more realtors using the system. For example, the consumer may be able to, through the consumer profile, communicate with a realtor who may be assisting the consumer in a real estate transaction or real estate service, such as selling real estate, purchasing real estate, leasing real estate, or other real estate services. In some instances, the consumer profile may also be viewable by the realtor through the system, such that the realtor may be able to have access to at least the above-mentioned information associated with the consumer profile. This may be undesirable for the consumer, as the realtor may have access to personal contact information of the consumer and may attempt to contact the consumer without the consumer's approval. Additionally, some or all of this information may also be included in any communications that take place between a consumer and a realtor. A consumer may desire to communicate with a realtor through the system to perform a real estate transaction, but may not want their personal consumer information disclosed to the realtor until a trusted relationship has been formed. A trusted relationship may be a relationship between a consumer and a realtor in which the consumer has indicated that the realtor is allowed to view personal consumer information of the consumer, identifying information of the consumer device associated with the consumer, or any other information.

Additionally, the consumer may access the real estate transaction system through a consumer device (for example, a smartphone, desktop computer, laptop computer, tablet, or any other type of device), and signals transmitted between the system and the consumer device may include identifying information regarding the consumer device (for example, a device type, a location of the consumer device, a MAC address, an IP address, or any other identifying information). If left unprotected, this identifying information may also be obtainable by realtors, and thus additional information about the consumer may be accessible.

In some embodiments, the systems and methods described herein may serve to anonymize information associated with the real estate transaction system, such as the consumer profile information and consumer device identifying information. This may allow the consumer to use the system and interact with realtors without the realtors being able to access any of this information without the consumer's permission. For example, it may be possible for a realtor to identify that a consumer profile for the consumer does exist on the system, but may not be able to view any of the aforementioned information associated with the consumer profile. Additionally, once interactions begin between a realtor and a consumer, any messages sent between the consumer and the realtor through the system may include minimal or no identifiable consumer information. For example, the messages may only include the consumer's first name, but any other personal contact information may be hidden and/or otherwise anonymized. Additionally, the identifying information associated with the consumer device that the consumer is using to access the system may also be hidden or otherwise unobtainable by the realtor (as well as any other users of the system). Thus, the realtor or other entity may be unable to contact the consumer outside of the anonymous communication channel, and the consumer may avoid unwanted calls, messages, or other communications.

In some embodiments, at any point during interactions with the realtor, the consumer may opt to make their consumer information public to the realtor through an indication that the interaction between the consumer and realtor is now a trusted interaction. That is, any messages exchanged between the consumer and the realtor through the system after the consumer has provide such an indication may include some or all of the consumer information associated with the consumer profile. Additionally, the realtor may now also have access to this information through the consumer's profile on the real estate transaction system. For example, the realtor may then have access to the consumer's telephone number, email address, or any other information associated with the consumer profile. In some embodiments, the realtor may also have access to identifying information associated with the consumer device, however, in alternative embodiments the realtor may only be granted access to the consumer's personal consumer information. The system may also provide the consumer the capability of selecting which types of information the realtor may have access to.

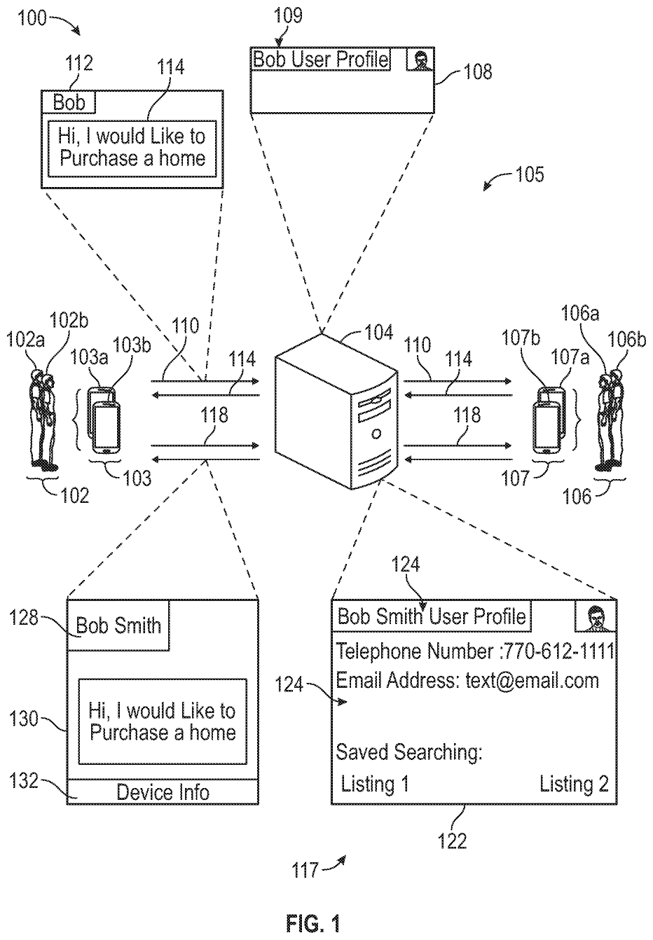

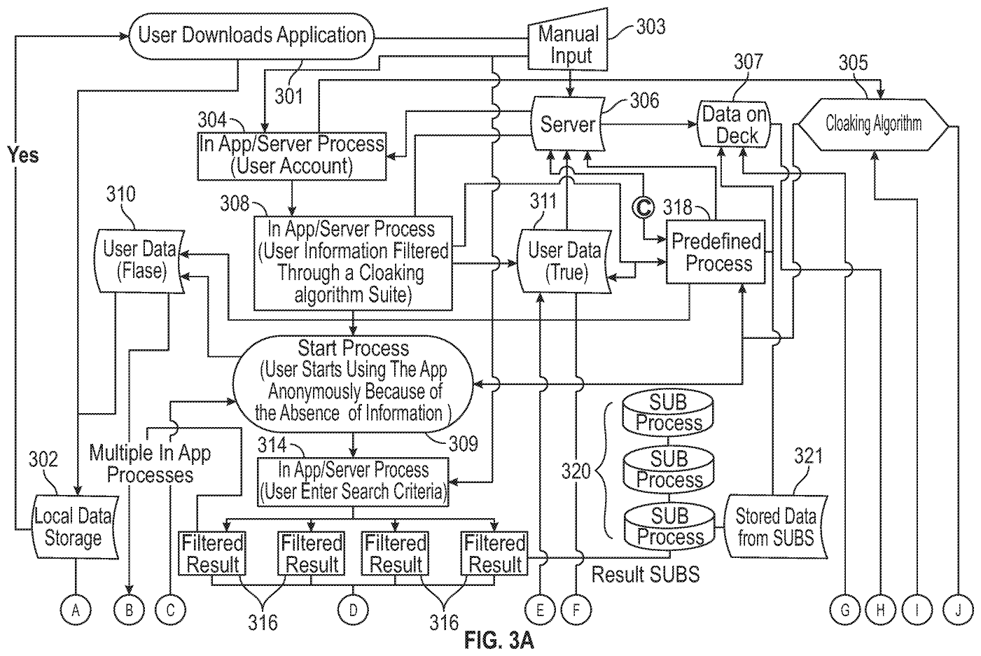

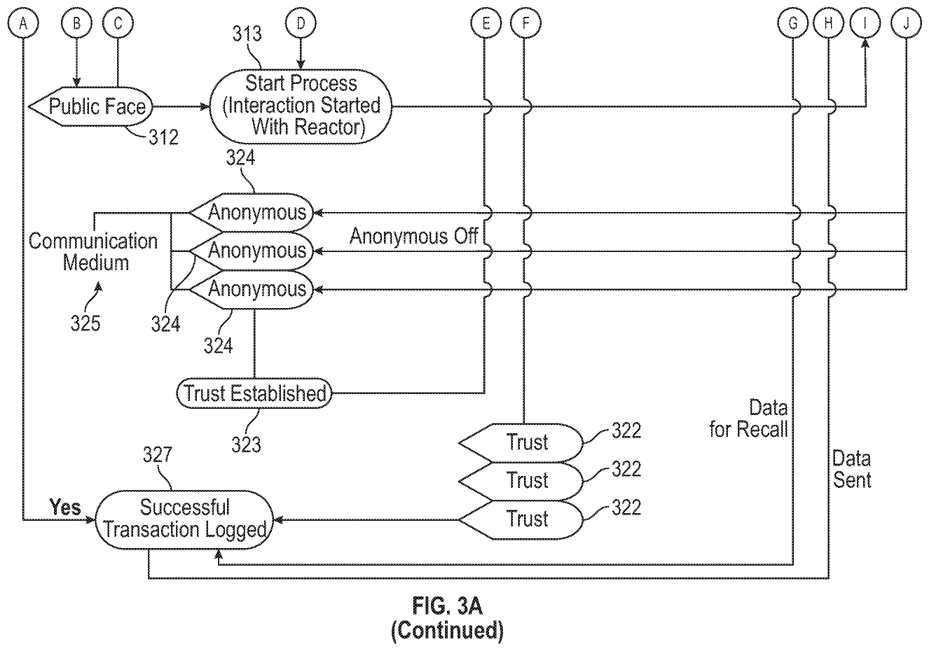

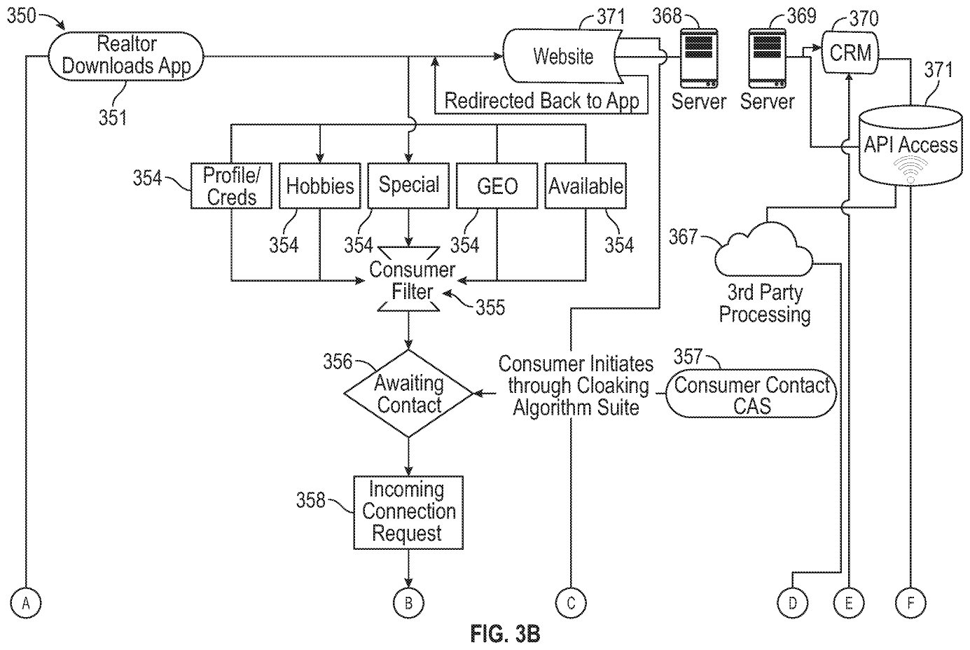

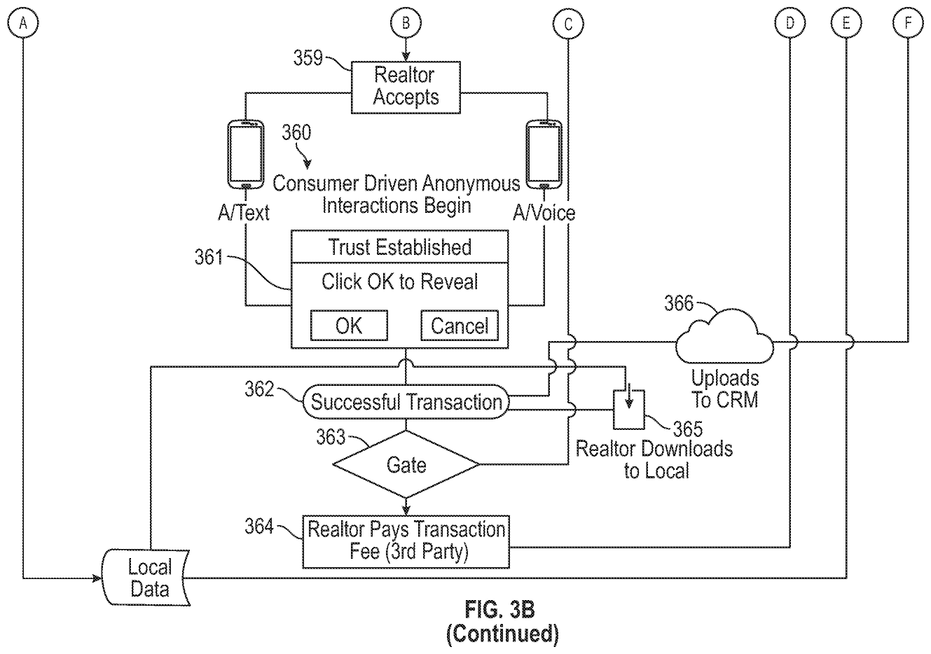

With reference to the figures, FIG. 1 includes a schematic diagram of an example use case 100 illustrating the anonymized real estate transaction system as described above. In some embodiments, the use case 100 may involve one or more consumers 102 (for example, consumer 102a and/or consumer 102b) that may be associated with one or more consumer devices 103 (for example, consumer device 103a and/or consumer device 103b). For simplicity sake, reference hereinafter may be made to consumer 102a and consumer device 103a, but any number of consumers and consumer devices may similarly be applicable (even beyond the two consumers and consumers devices depicted in the figure). Consumer device 103a may be in communication with a real estate transaction server 104. In some instances, the real estate transaction server 104 may house the anonymous real estate transaction system and all information associated with the system, such as consumer and realtor profiles, real estate listings, etc. The consumer 102a may use the consumer device 103a to access the real estate transaction system. The use case 100 may also include one or more realtors 106 (for example, realtor 106a and/or realtor 106b) that may be associated with one or more realtor devices 107 (for example, realtor device 107a and/or realtor device 107b). For simplicity sake, reference hereinafter may be made to realtor 106a and realtor device 107a, but any number of realtors and realtor devices may similarly be applicable (even beyond the two realtors and realtor devices depicted in the figure). The realtor device 107a may also be in communication with the real estate transaction server 104. The communications between the consumer device 103a, real estate transaction server 104, and/or the realtor device 107a may be via one or more networks wirelessly or wired, for example, as described with reference to FIG. 3 below.

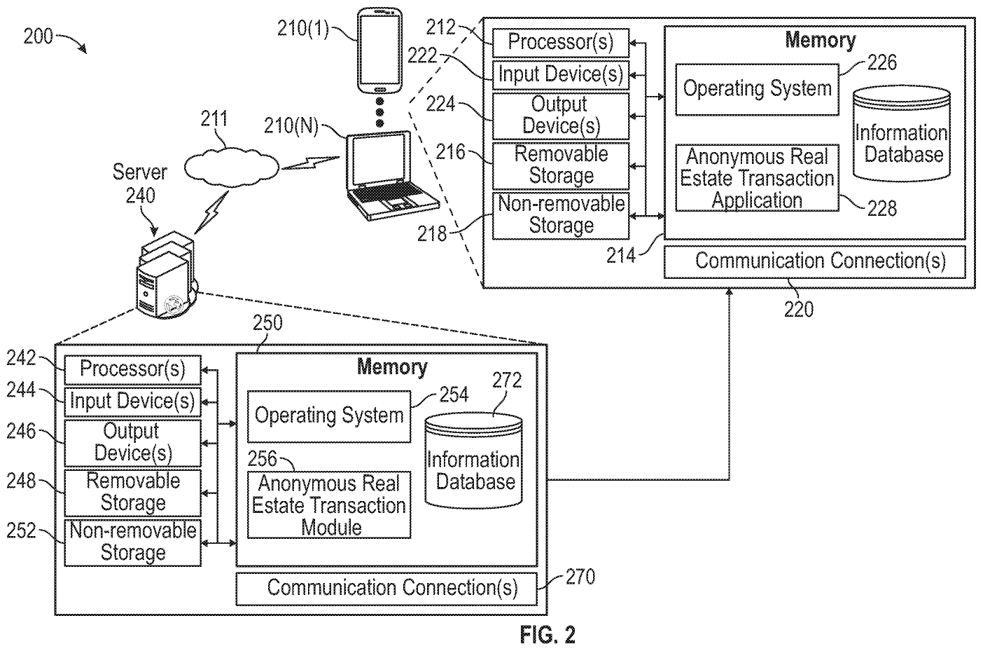

In some embodiments, an initial phase 105 of the use case 100 may involve initial interactions between the consumer 102a and the realtor 106a through the real estate transaction server 104. Initial interactions may include interactions that take place before the consumer 102a has opted to make their information accessible by the realtor 106a. As such, from the perspective of the realtor 106 during this time, a consumer profile 108 associated with the consumer 102a on the real estate transaction server 104 may be anonymized and thus may display minimal to no information about the consumer 102a to the realtor 106a. The information 109 viewable on the consumer profile 108 may include, for example, only a first name of the consumer 102a. However, even this information may be anonymized in the consumer profile 108. In some instances, the anonymization of only of the information described herein may be performed by the real estate transaction server 104. That is, the real estate transaction server 104 may include modules (such as the anonymous real estate transaction module 256 a described with respect to FIG. 2 and/or any other number or combinations of modules) used to anonymize any information stored at, or transmitted through, the real estate transaction server 104.

In some embodiments, during this initial phase 105 of the use case 100, the consumer 102a may, through the consumer device 103a, send a communication 110 to initiate an interaction with the realtor 106a (in some embodiments, however, the realtor may also send the initial communication). The communication 110 may include a message body 114. Similar to the consumer profile 108, the communication 110 may include minimal or no consumer information so that the realtor may not have access to this personal consumer information. In some embodiments, some information 112 may be provided, such as a first name of the consumer 102a, however, in alternative embodiments even this information may be anonymized or simply absent from the communication 110. Additionally, although not depicted in FIG. 1, the communication 110 may not include any identifying information associated with the consumer device 103a (for example, a location of the consumer device 103a, IP address, MAC address, or other identifying information), or such information may be anonymized as well. The communication 110 may be sent from the consumer device 103a to the real estate transaction server 104, which may then send the communication 110 to the realtor device 107a. That is, the real estate transaction server 104 may facilitate communications between the consumer 102a and the realtor 106a. In some embodiments, however, the communication 110 may be sent directly from the consumer device 103a to the realtor device 107a. The realtor 106a may then, through the realtor device 107a, respond to the communication 110 by sending a second communication 116 back to the consumer device 103a through the real estate transaction server 104. These communications (e.g., 110 and 116) may represent initial communications between the consumer and realtor regarding a potential real estate transaction, for example.

At any point subsequent to this initial phase 105 of the use case 100, or even prior to or during this initial phase 105, the consumer 102a may provide an indication to the real estate transaction server 104 that the realtor 106a is now trusted and information associated with the consumer 102a may be accessible by the realtor 106b (e.g., the information may no longer be anonymized by the real estate transaction server 104). In some instances, the indication may be in the form of the consumer 102a selecting an option on a graphical user interface (GUI) of the consumer device 103a. However, the indication may also be made in any number of other alternative ways, such as a selection of a setting in the consumer profile, an acceptance of a request for a trusted connection from a realtor profile 107a, etc. Based on this indication, the use case 100 may enter a second phase 117, and the consumer information may be made public to the realtor 106b (e.g., the information may no longer be anonymized by the real estate transaction server 104), such that the realtor 106b may be able to view the consumer information on the real estate transaction server 104 (for example, through the realtor device 107a). That is, during this second phase 117, consumer profile 122 may now display additional information 124 that was not originally displayed to the realtor 106a during the first phase 105. For example, the realtor 106a may now be able to view personal consumer information of the consumer 102a, such as their full name, telephone number, email address, other contact information, as well as other information, such as saved real estate searches performed by the consumer 102a on the real estate transaction server 104. In some embodiments, the indication by the consumer 102a may only make this information public to the specific realtor 106b approved by the consumer 102a, and other realtors (for example, realtor 106b) may still not have the capability to access the consumer information. That is, individual indications may be required for each realtor that the consumer interacts with.

During this second phase 117, communications may continue between the consumer 102a and realtor 106a through the real estate transaction server 104. In some instances, the consumer 102a may send a third communication 118 through the consumer device 103a to the real estate transaction server 104, which may then send the communication 118 to the realtor device 107a. The third communication 118 may include more consumer information 128 than the communication 110 sent prior to the consumer 102a making their information public to the realtor 106a. For example, the third communication 118 may include some of the additional information that is now viewable by the realtor 106a in the consumer profile 124. Additionally, in some embodiments the third communication 118 may also include identifying information for the consumer device 103a. However, in alternative embodiments, this identifying information may still be hidden to the realtor 106a.

### Illustrative System Architecture

FIG. 2 is a schematic illustration of example anonymous real estate transaction system 200 in accordance with one or more example embodiments of the disclosure. It should be noted that reference may be made herein to either a “real estate transaction system” or an “anonymous real estate transaction” system, but both terms may be interchangeable.

As shown in FIG. 2, the anonymous real estate transaction system 200 may include at least one or more computing devices 210(1), . . . , 210(N) and a server 240. The one or more computing devices may be the same as the consumer devices 103 and/or the realtor devices 107 described with reference to FIG. 1 above. Additionally, the server 240 may be the same as the real estate transaction server 104 described with respect to FIG. 1 above.

In some embodiments, communications between a computing device 210 and the server 240 may be via one or more networks 211, which may be wireless or wired networks. The one or more networks 211 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, the one or more networks may have any suitable communication range associated therewith and may include, for example, global networks (e.g., the Internet), metropolitan area networks (MANs), wide area networks (WANs), local area networks (LANs), or personal area networks (PANs). In addition, the one or more networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The computing devices 210(1), . . . , 210(N) may be any type of computing devices including, but not limited to, desktop personal computers (PCs), laptop PCs, mobile phones, smartphones, personal digital assistants (PDAs), tablet PCs, game consoles, set-top boxes, wearable computers, e-readers, web-enabled TVs, cloud-enabled devices and work stations, and the like. In certain aspects, the computing devices 210(1), . . . , 210(N) may include touch screen capabilities, motion tracking capabilities, imaging devices (e.g., infrared imaging devices, thermal imaging devices, etc.), microphones, vision tracking, etc. An imaging device may be a camera or any other suitable devices for capturing images or videos. In some instances, each computing device 210(1), . . . , 210(N) may be equipped with one or more processors and memory to store applications and data, such as an application that may display the composite imaging content.

In an illustrative configuration, a computing device 210 may be configured provide an interface for a user (for example a consumer 102a and/or a realtor 106a as described with reference to FIG. 1 above) to interact with the server 240. The computing device 210 may include at least a memory 214 and one or more processing units (or processors) 212. The processors 212 may be implemented as appropriate in hardware, software, firmware, or combinations thereof. Software or firmware implementations of the processors 212 may include computer-executable or machine-executable instructions written in any suitable programming language to perform the various functions described.

The memory 214 may store program instructions that are loadable and executable on the processors 212, as well as data generated during the execution of these programs. Depending on the configuration and type of the computing device 210, the memory 214 may be volatile (such as random access memory (RAM)) and/or non-volatile (such as read-only memory (ROM), flash memory, etc.). The computing device 210 or server may also include additional removable storage 216 and/or non-removable storage 218 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 214 may include multiple different types of memory, such as static random access memory (SRAM), dynamic random access memory (DRAM), or ROM.

The memory 214, the removable storage 216, and the non-removable storage 218 may be all examples of computer-readable storage media. For example, computer-readable storage media may include volatile and non-volatile, removable and non-removable media implemented in any method or technology for the storage of information such as computer-readable instructions, data structures, program modules, or other data. The memory 214, the removable storage 216, and the non-removable storage 218 may be all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the desired information and which can be accessed by the computing device 210 or other computing devices. Combinations of any of the above should also be included within the scope of computer-readable media.

Alternatively, computer-readable communication media may include computer-readable instructions, program modules, or other data transmitted within a data signal, such as a carrier wave, or other transmissions. However, as used herein, computer-readable storage media does not include computer-readable communication media.

The computing device 210 may also contain communication connection(s) 220 that allows the computing device 210 to communicate with a stored database, another computing device or server, user terminals, and/or other devices on a network. The computing device 210 may also include input device(s) 222 such as a keyboard, a mouse, a pen, a voice input device, a touch input device, etc., and output device(s) 224, such as a display, speakers, printers, etc.

Turning to the contents of the memory 214 in more detail, the memory 214 may include an operating system 226 and one or more application programs or services for implementing the features disclosed herein, including an anonymous real estate transaction application 228.

The anonymous real estate transaction application 228 including computer-executable instructions, code, or the like that responsive to execution by one or more of the processor(s) 212 may perform functions including, but not limited to, providing personal consumer information, the personal consumer information including at least a name of a consumer associated with the consumer device. The functions may also include providing a request including at least one of: a request to perform a real estate sale or a request to search for real estate for purchase, the request including one or more search criteria, the search criteria including at least one of: consumer preferences, a geographical location, or a price range. The functions may also include receiving the realtor profile. The functions may also include providing an indication of an acceptance of a connection between the consumer profile and the realtor profile, the connection allowing an interaction between the consumer profile and the realtor profile. The functions may also include providing a first communication regarding the real estate sale or a request to search for real estate for purchase. The functions may also include providing an indication of a trusted connection with the realtor profile, the trusted connection allowing the realtor profile to view the personal consumer information of the consumer profile. Additionally, the functions may include execution of any other methods and/or processes described herein. Further, while the functions described above may be described from the perspective of a consumer device, similar functions may be executed from a realtor device.

Referring now to other illustrative components depicted in FIG. 2, the server 240 may be configured to communicate with the computing device 210 and may host the anonymous real estate transaction system. That is, the server 240 may also store information associated with all of the users of the system, such as consumer profile and realtor profile information, as well as all of the real estate posting, and any other data associated with the system. Additionally, the anonymization of consumer information and consumer device identifying information may take place on server 240.

In some embodiments, the server 240 may include some similar elements as the computing device 210. The server 240 may include at least a memory 250 and one or more processing units (or processors) 242. The processors 242 may be implemented as appropriate in hardware, software, firmware, or combinations thereof. Software or firmware implementations of the processors 242 may include computer-executable or machine-executable instructions written in any suitable programming language to perform the various functions described.

The memory 250 may store program instructions that are loadable and executable on the processors 242, as well as data generated during the execution of these programs. Depending on the configuration and type of the server 240 , the memory 250 may be volatile (such as random access memory (RAM)) and/or non-volatile (such as read-only memory (ROM), flash memory, etc.). The server 240 or server may also include additional removable storage 248 and/or non-removable storage 252 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 250 may include multiple different types of memory, such as static random access memory (SRAM), dynamic random access memory (DRAM), or ROM.

The memory 250, the removable storage 248, and the non-removable storage 252 may be all examples of computer-readable storage media. For example, computer-readable storage media may include volatile and non-volatile, removable and non-removable media implemented in any method or technology for the storage of information such as computer-readable instructions, data structures, program modules, or other data. The memory 250, the removable storage 248, and the non-removable storage 252 may be all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the desired information and which can be accessed by the server 240 or other computing devices. Combinations of any of the above should also be included within the scope of computer-readable media.

Alternatively, computer-readable communication media may include computer-readable instructions, program modules, or other data transmitted within a data signal, such as a carrier wave, or other transmissions. However, as used herein, computer-readable storage media does not include computer-readable communication media.

The server 240 may also contain communication connection(s) 270 that may allow the server 240 to communicate with a stored database, another computing device or server, user terminals, and/or other devices on a network. The server 240 may also include input device(s) 244 such as a keyboard, a mouse, a pen, a voice input device, a touch input device, etc., and output device(s) 246, such as a display, speakers, printers, etc.

Turning to the contents of the memory 250 in more detail, the memory 250 may include an operating system 254 and one or more application programs or services for implementing the features disclosed herein, including an anonymous real estate transaction module 256.

The anonymous real estate transaction module 256, including computer-executable instructions, code, or the like that responsive to execution by one or more of the processor(s) 242 may perform functions including, but not limited to, receiving, by a server and from a real estate transaction application of a consumer device, personal consumer information, the personal consumer information including at least a name of a consumer associated with the consumer device. The functions may also include storing, by the server, the personal consumer information in a consumer profile associated with the consumer. The functions may also include receiving, by the server and from the consumer device, a request including at least one of: a request to perform a real estate sale or a request to search for real estate for purchase, the request including one or more search criteria, the search criteria including at least one of: consumer preferences, a geographical location, or a price range. The functions may also include identifying, based on the one or more search criteria, a realtor profile stored at the server. The functions may also include providing the realtor profile to the consumer device. The functions may also include receiving, from the consumer device, an indication of an acceptance of a connection between the consumer profile and the realtor profile, the connection allowing an interaction between the consumer profile and the realtor profile. The functions may also include receiving a first communication from the consumer device regarding the real estate sale or a request to search for real estate for purchase. The functions may also include sending the first communication to a realtor device associated with the realtor profile, the first communication being absent of the personal consumer information, the first communication also being absent of identifying information of the consumer device and also being absent of geolocation information of the consumer device. The functions may also include receiving, from the consumer device, an indication of a trusted connection with the realtor profile, the trusted connection allowing the realtor profile to view the personal consumer information of the consumer profile. The functions may also include sending, based on receiving the indication of the trusted connection, a second communication to the realtor profile, the second communication including the personal consumer information. Additionally, the functions may include execution of any other methods and/or processes described herein.

Program modules, applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database task or search language, or a report writing language. In one or more example embodiments, a software component comprising instructions in one of the foregoing examples of programming languages may be executed directly by an operating system or other software components without having to be first transformed into another form.

A software component may be stored as a file or other data storage construct. Software components of a similar type or functionally related may be stored together, such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines, and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

### Illustrative Processes

FIG. 3A depicts an example system flow diagram 300 from a consumer perspective. For example, FIG. 3A may represent a system flow diagram as executed from the perspective of a consumer using a consumer device to interact with the real estate transaction system. In some embodiments, the system flow diagram 300 may begin at 301 with a consumer downloading a real estate transaction application to the consumer device. In some instances, the real estate transaction application may be a smartphone application and the consumer device may be a smartphone of the consumer. The consumer may also access a website associated with the real estate transaction system. In some instances, the website may redirect the consumer to download the real estate transaction application, or if the application is already installed on the v device, may simply open the application. Upon downloading and installing the application on the consumer device, the consumer may, at 303, provide inputs through the consumer application on the consumer device to the real estate transaction system. For example, the inputs may be in the form of information used to create a consumer profile for the consumer on the system. Such account creation may occur at 304. The information may include, for example, personal consumer information, such as a name, a telephone number, a current address, an email address, real estate preferences, etc. At 306, the information may be stored at a server 306, which may be a server that hosts the real estate transaction system, such as the server 104 with respect to FIG. 1 and/or the server 240 with respect to FIG. 2 (or any other server described herein). At 308, the information provided by the consumer may be filtered through a cloaking algorithm, which may serve to anonymize the information such that the information may not be viewable by any other user of the real estate transaction system (e.g., other consumers or realtors). Additionally, other types of information may also be anonymized by the server 306, such as identifying information associated with the consumer device providing the information (e.g., location information, IP address, MAC address, device type, etc.).

In some embodiments, at 309 the consumer may initiate usage of the real estate transaction application in an anonymous manner as a result of the cloaking algorithm. During usage of the real estate transaction application, the consumer may, at 314, enter search criteria into a graphical user interface (GUI) of the application. The search criteria may include criteria used by the real estate transaction system to identify real estate that is characterized by the provided criteria. For example, criteria may include consumer preferences, a geographical location, a price range, a number of bedrooms, or a number of bathrooms, as well as any other information relevant to filtering real estate listings. Based on entering this search criteria, the consumer may be provided with one or more filtered results 316. The one or more filtered results 316 may represent real estate listings that are determined to meet the search criteria of the consumer. The one or more filtered results 316 may also be associated with one or more realtor profiles. In some instances, the one or more realtor profiles may be associated with each of the filtered real estate postings based on the criteria the consumer provided. For example, a first filtered result may be for a real estate entry in County A, and one or more realtors may be provided that service that county. Subsequent to receiving the one or more filtered results, the consumer may select one of the real estate entries, may select a realtor associated with the real estate entries, or may select both. This may initiate an interaction with a realtor at 313. This interaction may be the same or similar an interaction as described with reference to FIG. 1 above. That is, the interaction may involve communications between the consumer profile and realtor profile on the real estate transaction system in order to facilitate a real estate transaction. By default, at 310 a setting associated with the consumer profile may indicate that information associated with the consumer profile may be anonymized and unviewable by the realtor. This information may also be anonymized or absent in any communications between the consumer and realtor (for example as shown at 324). In some instances minimal information may be included, however, such as a first name of the consumer. At any point during the interaction, the consumer may indicate at 311 that the interaction with the realtor is a trusted interaction and that the consumer profile information should be made accessible to the realtor (e.g., the cloaking algorithm may cease anonymizing some or all of the information). Additionally, this information may now be included (or may no longer be anonymized) in communications between the consumer and realtor (for example, as shown at 322). These trusted communications may continue until the real estate transaction is completed at 327.

FIG. 3B depicts an example system flow diagram 350 regarding an example use of the real estate transaction system from a realtor perspective. For example, FIG. 3B may represent a system flow diagram as executed from the perspective of a realtor using a realtor device to interact with the real estate transaction system. In some embodiments, the system flow diagram 350 may begin at 351 with a realtor downloading a real estate transaction application to a realtor device. In some instances, the real estate transaction application may be a smartphone application and the realtor device may be a smartphone of the realtor. The realtor may also access a website associated with the real estate transaction system at 371. In some instances, the website may redirect the realtor to download the real estate transaction application, or if the application is already installed on the realtor device, may simply open the application. The website may also be associated with a server 368, which may be a server that hosts the real estate transaction system. At 354, the realtor may input realtor profile information into the real estate transaction application to create a realtor profile. The information may include, for example, credentials, hobbies, geolocation information, availability information, etc. The realtor profile may be stored in the real estate transaction system, for example, at the server 368. Subsequent to the creation of the realtor profile, some or all of this information provided to the realtor profile at 354 may be provided to a consumer filter at 355. The consumer filter may be used to match the realtor to a consumer based on search criteria the consumer may enter into the real estate transaction system. The matching may be performed to facilitate an interaction between the consumer and the realtor. The interaction, for example, may involve the realtor assisting the consumer in completing a real estate transaction for particular real estate returned to the consumer through their search. For example, the consumer may be searching for homes on sale in a particular county, and the geolocation information provided by the realtor in the realtors profile may indicate that the realtor services that county, so the real estate transaction system may match the consumer to the realtor on that basis. At 356, the system be awaiting consumer search queries that would appropriately result in a match with the realtor profile. At 358, a match may be made between a realtor profile and a consumer. Alternatively, a consumer may directly request a connection with the realtor based on the realtor profile. At 359, the realtor may accept the connection request from the consumer or the system, which may initiate interactions between the consumer and realtor. At 360, interactions may take place between the consumer and realtor. Such interactions may involve at least the interactions described with respect to FIG. 1 above. For example, interactions may involve communications transmitted between the consumer and realtor through the real estate transaction system. Also as described with respect to FIG. 1, these interactions may initially involve consumer profile and other information being anonymized and/or hidden from the realtor. Such information may continue to be anonymized and/or hidden from the realtor until the consumer indicates that a trust is established with the realtor. As depicted in FIG. 3B, the consumer may make such an indication, for example, by selecting an option on a prompt box on the consumer device. The indication, however, may also be provided in any number of other ways as described herein or otherwise. Once the consumer provides this indication, the realtor may then have access to some or all of the consumer information stored at the real estate transaction server. The realtor may also have access to identifying information associated with the consumer device. In some instances, however, only some of this aforementioned information may be accessible by the realtor subsequent to the trust indication by the consumer. The consumer and realtor interactions may continue until the real estate transaction is successfully completed at 362.

In some embodiments, upon completion of the transaction, at 365 the realtor may download transaction information to a local device, which may be the realtor device. At 366, the realtor may also upload the transaction information to a server 370, which may be, for example, a customer relationship management (CRM) system. At 364, the realtor may also pay a transaction fee to a third party, which may involve third party processing at 367.

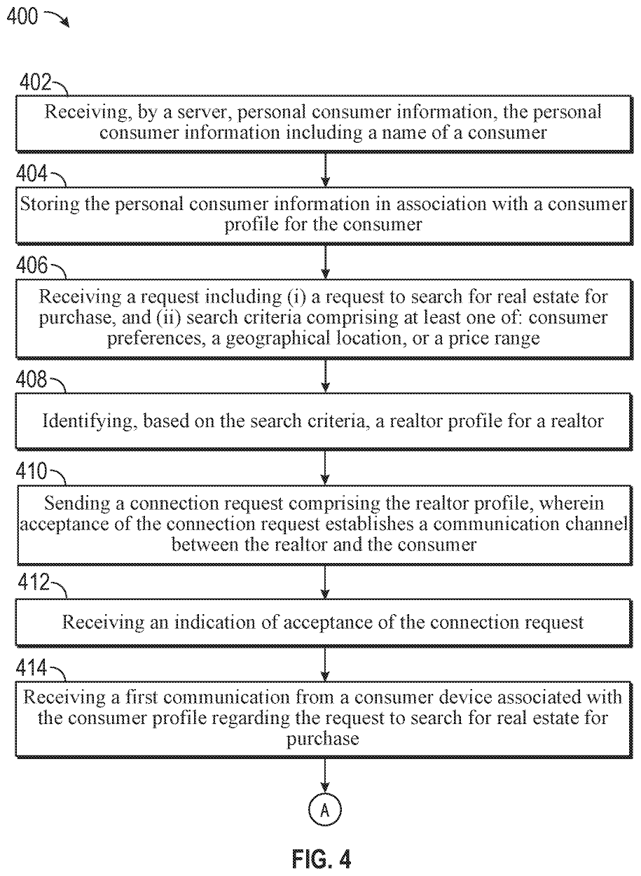

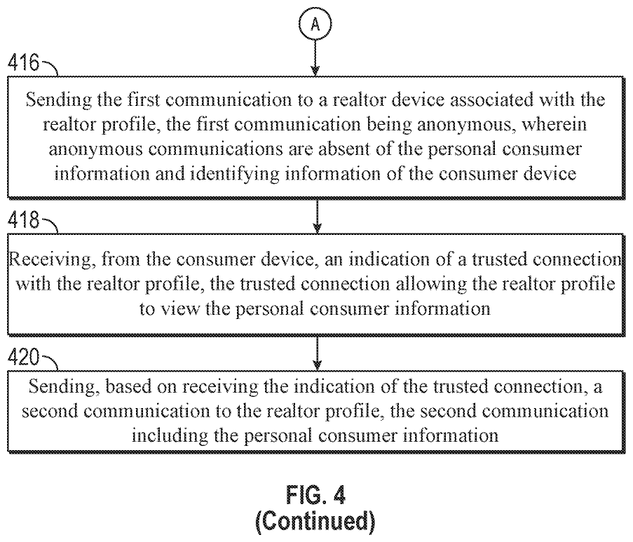

FIG. 4 is an example method 400 for anonymizing a real estate transaction system in accordance with one or more example embodiments of the disclosure. In some embodiments, anonymizing the real estate transaction system may allow a consumer to sign up for an account, create a profile with personal and other information, and use the real estate transaction system without other users (e.g., realtor profiles) being able to access the consumer information. The anonymizing may also allow the consumer to interact and exchange communications with a realtor that may also be using the real estate transaction system without the same information being accessible by the realtor while in communication with the consumer. The anonymizing may also allow identifying information associated with a consumer device that the consumer may use to access the real estate transaction system (e.g., a smartphone, laptop, etc.) to be anonymized as well. In FIG. 4, computer-executable instructions of one or more module(s) of the anonymous real estate transaction system 300, such as the modules of the server 340 may be executed to perform an anonymous real estate transaction.

At block 402 of the method 400 in FIG. 4, the method may include receiving, by a server, personal consumer information, the personal consumer information including a name of a consumer. In some instances, such information may be received during creation or modification of a consumer profile of the consumer. The personal consumer information may include any other type of information associated with the consumer, such as a telephone number, email address, current residential address, etc. The consumer may also provide other types of information, such as real estate preferences (e.g., desired real estate location, features, etc.).

Block 404 of the method 400 may include storing the personal consumer information in association with a consumer profile for the consumer. Storing such information may provide convenience for the consumer in using the real estate transaction system as such storage may enable the consumer to use such information for future processes of the system without having to manually re-enter the information during each instance of a process. As a non-limiting example, at some point during a transaction, a consumer may want to provide their contact information to the other party involved in the transaction, a realtor, or any other type of user. The consumer may also desire to share such information with a realtor during a real estate transaction, but may not desire to do so until a certain level of trust is developed with a realtor. Thus, the information is stored and anonymized, but available if the consumer opts to make the information public to a realtor.

Block 406 of the method 400 may include receiving a request including (i) a request to search for real estate for purchase, and (ii) search criteria comprising at least one of: consumer preferences, a geographical location, or a price range. In other words, the request may be in the form of the consumer entering a search into the real estate transaction system or creating a posting to sell their own real estate. For example, the consumer may be interested in searching the system for homes in a particular city and within a particular price range. The user may enter this search criteria through an application on the consumer device, and this search may be provided to the real estate transaction system, which may, as described herein, be hosted on a server in communication with the consumer device.

Block 408 of the method 400 may identifying, based on the search criteria, a realtor profile for a realtor. For example, realtors using the real estate transaction system may create their own profiles on the system. The realtor profile may include information input by the realtor, such as the realtor's personal contact information, credentials, location, etc. The real estate transaction system may use the criteria entered by the consumer and match the criteria to information associated with one or more realtor profiles stored in the system. For example, the consumer search criteria may include the real estate being located in County A. The system may search stored realtor profiles for realtors that conduct business in County A.

Block 410 of the method 400 may include sending a connection request comprising the realtor profile, wherein acceptance of the connection request establishes a communication channel between the realtor and the consumer. The consumer may then be able to select a realtor from the list of realtors to interact with to performing a transaction regarding the real estate search result. Alternatively, the system may simply match a realtor to the consumer as an alternative to providing a list of potential realtors for selection by the consumer.

Block 412 of the method 400 may include receiving an indication of acceptance of the connection request. The indication of the acceptance may be performed in a number of ways, such as selection of a realtor profile from a provided listing of profiles, for example.

Block 414 of the method 400 may include receiving a first communication from a consumer device associated with the consumer profile regarding the request to search for real estate for purchase. The communication maybe in the form of a message from the consumer device to the real estate transaction system. The communication may represent an initial message from the consumer to the realtor subsequent to the consumer accepting the connection. Alternatively, the realtor may also send this first communication to the consumer.

Block 416 of the method 400 may include sending the first communication to a realtor device associated with the realtor profile, the first communication being anonymous, wherein anonymous communications are absent of the personal consumer information and identifying information of the consumer device. The communication being absent of any of this information may mean that the information is present and anonymized, or that it is simply not included by the server in the communication. As described above, in additional to communications between the consumer and realtor, any other information associated with the consumer (e.g., in the consumer profile) may also be anonymized by the server so that the realtor may not simply access the consumer information in the server outside of the communications.

Block 418 of the method 400 may include receiving, from the consumer device, an indication of a trusted connection with the realtor profile, the trusted connection allowing the realtor profile to view the personal consumer information. The indication of the trusted connection may be performed in any number of ways. For example, the trust connection indication may be provided through an input to a GUI of an application running on the consumer device.

Block 420 of the method 400 may include sending, based on receiving the indication of the trusted connection, a second communication to the realtor profile, the second communication including the personal consumer information. That is, once the consumer indicates that the interaction with the particular realtor is trusted, the personal consumer information, identifying information of the consumer device, and/or any other information may no longer be anonymized. This may allow for more effective communications between the consumer and realtor to allow the real estate transaction to be completed. In some embodiments, only some of the aforementioned information may be made public based on the indication, however. A determination as to which of the information should be made public may be based on a consumer selection.

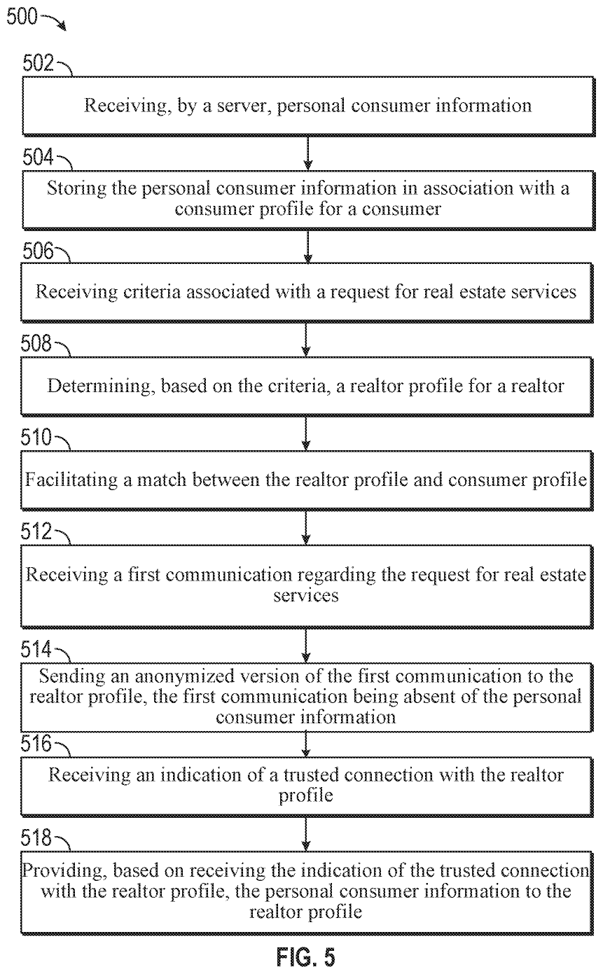

FIG. 5 is an example method 500 for anonymizing a real estate transaction system in accordance with one or more example embodiments of the disclosure. In FIG. 5, computer-executable instructions of one or more module(s) of the anonymous real estate transaction system 300, such as the modules of the server 340 may be executed to perform an anonymous real estate transaction. At block 502 of the method 500 in FIG. 5, the method may include receiving, by a server, personal consumer information. Block 504 of the method 500 may include storing the personal consumer information in association with a consumer profile for a consumer. Block 506 of the method 500 may include receiving criteria associated with a request for real estate services. Block 508 of the method 500 may include determining, based on the criteria, a realtor profile for a realtor. Block 510 of the method 500 may include facilitating a match between the realtor profile and consumer profile. Block 512 of the method 500 may include receiving a first communication regarding the request for real estate services. Block 514 of the method 500 may include sending an anonymized version of the first communication to the realtor profile, the first communication being absent of the personal consumer information. Block 516 of the method 500 may include receiving an indication of a trusted connection with the realtor profile. Block 518 of the method 500 may include providing, based on receiving the indication of the trusted connection with the realtor profile, the personal consumer information to the realtor profile.

The operations described and depicted in the illustrative process flows of FIGS. 4-5 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 4-5 may be performed.

One or more operations of the process flows of FIGS. 4-5 may have been described above as being performed by a user device, or more specifically, by one or more program modules, applications, or the like executing on a device. It should be appreciated, however, that any of the operations of process flows of FIGS. 4-5 may be performed, at least in part, in a distributed manner by one or more other devices, or more specifically, by one or more program modules, applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the process flows of FIGS. 4-5 may be described in the context of the illustrative object tracking system, it should be appreciated that such operations may be implemented in connection with numerous other device configurations.

It should further be appreciated that the server 340 may include alternate and/or additional hardware, software, or firmware components beyond those described or depicted without departing from the scope of the disclosure. More particularly, it should be appreciated that software, firmware, or hardware components depicted as forming part of the server 340 are merely illustrative and that some components may not be present or additional components may be provided in various embodiments. While various illustrative program modules have been depicted and described as software modules stored in data storage, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

That which is claimed is:

1. A method comprising:
receiving, by a server, personal consumer information;
storing the personal consumer information in association with a consumer profile for a consumer;
receiving criteria associated with a request for real estate services;
determining, based on the criteria, a realtor profile for a realtor;
facilitating a match between the realtor profile and consumer profile;
receiving a first communication regarding the request for real estate services;
sending an anonymized version of the first communication to the realtor profile, the first communication being absent of the personal consumer information;
receiving an indication of a trusted connection with the realtor profile; and
providing, based on receiving the indication of the trusted connection with the realtor profile, the personal consumer information to the realtor profile.

2. The method of claim 1, further comprising:
sending a second communication to the realtor profile, the second communication including the personal consumer information.

3. The method of claim 1, wherein the first communication is also absent of identifying information associated with a consumer device of the consumer and geolocation information associated with the consumer device.

4. The method of claim 3, wherein the identifying information associated with the consumer device includes at least one of: a device type, a MAC address, an IP address, or a phone number.

5. The method of claim 1, wherein the personal consumer information for the consumer profile includes at least one of: a name of a consumer associated with the consumer profile, an email address, a telephone number, or a current residential address.

6. The method of claim 1, wherein the trusted connection also allows the realtor profile to view identifying information of a consumer device associated with the consumer.

7. The method of claim 1, wherein the criteria includes at least one of: consumer preferences, a geographical location, a price range, a number of bedrooms, or a number of bathrooms.

8. The method of claim 1, further comprising:
receiving, from a second realtor profile, a request to view the personal consumer information of the consumer profile; and
denying the request from the second realtor profile to view the personal consumer information of the consumer profile.

9. A system comprising memory coupled to at least one processor, the at least one processor configured to:
receive, by a server and from a consumer device, personal consumer information;
store the personal consumer information in a consumer profile associated with the consumer;
receive, from the consumer device, criteria associated with a request to perform a real estate sale or a request to search for real estate for purchase;
identify, based on the criteria, a realtor profile associated with the server;
facilitate a match between the realtor profile and consumer profile;
receive a first communication from the consumer device regarding the a request to perform a real estate sale or a request to search for real estate for purchase;
send the first communication to the realtor profile, the first communication being absent of the personal consumer information;
receive, from the consumer device, an indication of a trusted connection with the realtor profile; and
provide, based on receiving the indication of the trusted connection with the realtor profile, the personal consumer information to the realtor profile.

10. The system of claim 9, wherein the at least one processor is further configured to:
provide, based on receiving the indication of the trusted connection with the realtor profile, the personal consumer information to the realtor profile; and
send a second communication to the realtor profile, the second communication including the personal consumer information.

11. The system of claim 9, wherein the first communication is also absent of identifying information associated with a device associated with the consumer profile and geolocation information associated with the device.

12. The system of claim 11, wherein the identifying information associated with the device includes at least one of: a device type, a MAC address, an IP address, or a phone number.

13. The system of claim 9, wherein the personal consumer information for the consumer profile includes at least one of: a name of a consumer associated with the consumer profile, an email address, a telephone number, or a current residential address.

14. The system of claim 9, wherein the trusted connection also allows the realtor profile to view identifying information of the consumer device.

15. The system of claim 14, wherein the criteria includes at least one of: consumer preferences, a geographical location, a price range, a number of bedrooms, or a number of bathrooms.

16. The system of claim 9, wherein the at least one processor is further configured to:
receive, from a second realtor profile, a request to view the personal consumer information of the consumer profile; and
deny the request from the second realtor profile to view the personal consumer information of the consumer profile.

17. A method comprising:
receiving, by a server, personal consumer information, the personal consumer information including a name of a consumer;
storing the personal consumer information in association with a consumer profile for the consumer;
receiving a request including (i) a request to search for real estate for purchase, and (ii) search criteria comprising at least one of: consumer preferences, a geographical location, or a price range;
identifying, based on the search criteria, a realtor profile for a realtor;
sending a connection request comprising the realtor profile, wherein acceptance of the connection request establishes a communication channel between the realtor and the consumer;
receiving an indication of acceptance of the connection request;
receiving a first communication from a consumer device associated with the consumer profile regarding the request to search for real estate for purchase;
sending the first communication to a realtor device associated with the realtor profile, the first communication being anonymous, wherein anonymous communications are absent of the personal consumer information and identifying information of the consumer device;
receiving, from the consumer device, an indication of a trusted connection with the realtor profile, the trusted connection allowing the realtor profile to view the personal consumer information; and
sending, based on receiving the indication of the trusted connection, a second communication to the realtor profile, the second communication including the personal consumer information.

18. The method of claim 17, wherein the identifying information associated with the consumer device includes at least one of: a device type, a MAC address, an IP address, or a phone number.

19. The method of claim 17, further comprising:
receiving, from the realtor profile, a request to view the personal consumer information of the consumer profile; and
providing, based on receiving the request to view the personal consumer information and based on receiving the indication of the trusted connection, the personal consumer information to the realtor profile.

20. The method of claim 17, further comprising:
receiving, from a second realtor profile, a request to view the personal consumer information of the consumer profile; and
denying the request from the second realtor profile to view the personal consumer information of the consumer profile.
